(19) United States
(12) Patent Application Publication
(10) Pub. No.: US 2008/0047099 A1
(43) Pub. Date: Feb. 28, 2008

(54) SEALING PLUG FOR WINDOW JAMB OF GUILLOTINE WINDOW

(76) Inventor: Neeman Malek, Lorraine (CA)

Correspondence Address: OGILVY RENAULT LLP, 1981 MCGILL COLLEGE AVENUE, SUITE 1600, MONTREAL, QC, H3A2Y3, US

(21) Appl. No.: 11/840,510

(22) Filed: Aug. 17, 2007

Related U.S. Application Data
(60) Provisional application No. 60/823,222, filed on Aug. 22, 2006.
(60) Provisional application No. 60/894,297, filed on Mar. 12, 2007.

(51) Int. Cl. E05C 17/64; E05D 13/00; E05D 15/16; E05F 1/00

(52) U.S. Cl. 16/197; 16/404

(57) ABSTRACT

A sealing plug for a block-and-tackle balance comprises a sealing member having an outer periphery shaped so as to conform to an inner surface of a channel of a window jamb in which the block-and-tackle balance is accommodated. An opening is defined in the sealing member allowing a cord of the block-and-tackle balance to pass therethrough such that the cord is movable with a movement of a window panel. A connector configuration in the sealing member and allows the sealing member to be releasably secured to a bottom end of the block-and-tackle balance.

### CROSS-REFERENCE TO RELATED APPLICATIONS

This patent application claims priority on U.S. Provisional Patent Applications No. 60/823,222, filed on Aug. 22, 2006, and No. 60/894,297, filed on Mar. 12, 2007.

### FIELD OF THE APPLICATION

The present invention relates to guillotine or vertical sliding sash-type windows and, more particularly, to the sealing of jambs of such windows against air/water infiltration.

### BACKGROUND ART

With a temperature differential between the inside and the outside of a building, a pressure differential is usually present between the inside and outside of the building, because of the difference in the density of the air. Accordingly, because of the temperature differential, a chimney effect produces a negative inside pressure relative to the outside, and this causes infiltration at lower levels, and a positive pressure and exfiltration at higher levels.

In vertical sliding windows, various mechanisms are used to assist an operator in displacing the sash window panel to an opened/closed position. For instance, block-and-tackle balances are positioned in jamb portions and support the sash window panel by way of a spring mechanism and pulleys. However, the jamb portions enclosing such balances are subjected to air/water infiltration.

### SUMMARY OF THE APPLICATION

It is therefore an aim of the present invention to provide a novel sealing plug for window sash jambs to address issues associated with the prior art.

Therefore, in accordance with the present application, there is provided a sealing plug for a block-and-tackle balance comprising: a sealing member having an outer periphery shaped so as to conform to an inner surface of a channel of a window jamb in which the block-and-tackle balance is accommodated; an opening in the sealing member allowing a cord of the block-and-tackle balance to pass therethrough such that the cord is movable with a movement of a window panel; and a connector configuration in the sealing member and releasably secured to a bottom end of the block-and-tackle balance.

Further in accordance with the present application, there is provided a block-and-tackle balance assembly comprising: a block-and-tackle balance having a U-shaped housing positioned vertically in a channel of a window jamb, the block-and-tackle balance having a biasing mechanism accommodated in the U-shaped housing and a cord connected to the biasing mechanism and projecting from a bottom end of the U-shaped housing to support a shoe connected with a sash window panel; and a sealing plug having a sealing member with an outer periphery shaped so as to conform to the channel of the window jamb, an opening in the sealing member allowing the cord to pass therethrough such that the cord is movable with a movement of the shoe, the sealing member being releasably secured to the bottom end of the block-and-tackle balance by a connector configuration.

### BRIEF DESCRIPTION OF THE FIGURES

FIG. 1 is a perspective view, sectioned, of a guillotine window system;

FIG. 2A is an underside perspective view, sash side, of the plug in accordance with the embodiment of the present invention;

FIG. 2B is an underside perspective view, window side, of the plug of FIG. 2A;

FIG. 2C is an upperside perspective view, sash side, of the plug of FIG. 2A;

FIG. 2D is an underside perspective view, window side, of the plug of FIG. 2A;

FIG. 3 is an assembly view, sectioned, of a block-and-tackle balance having the plug of FIG. 2A, with respect to a jamb portion;

FIG. 4 is an assembly view, sectioned, of the block-and-tackle balance having the plug of FIG. 2A and inserted in the jamb portion;

FIG. 5 is a bottom plan view of a jamb portion having a block-and-tackle balance with the plug of FIG. 2A and another without plug;

FIG. 6 is a top plan view of a jamb portion having a block-and-tackle balance with the plug in accordance with another embodiment and another with the plug of FIG. 2A, with respect to a tilt latch; and

FIG. 7A is an elevation view of the block-and-tackle balance having the plug of FIG. 6, for a first-side jamb; and

FIG. 7B is an elevation view of the block-and-tackle balance having the plug of FIG. 6, for a second-side jamb.

### DESCRIPTION OF THE PREFERRED EMBODIMENTS

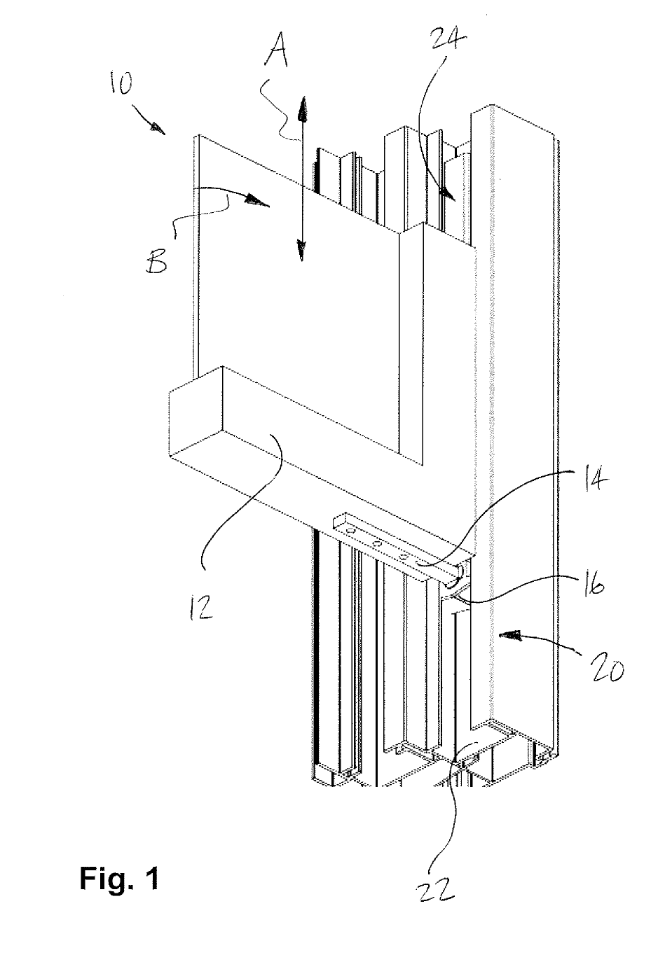

Referring now to the drawings, and more particularly to FIG. 1, a guillotine window system is generally shown at 10. The window system 10 has a sash window panel 12, which is translatable along direction A between a maximum opening position of the window system 10, a closed position, and various degrees of opening between these extreme positions.

The sash window panel 12 is mounted to the window frame by way of a pivot 14 received in a shoe 16 of a balance. In the embodiment illustrated in FIG. 1, the shoe 16 serves as a pivot support, and is provided with a pivoting member in which the pivot 14 is engaged in such a way that the sash window panel 12 may be pivoted along direction B.

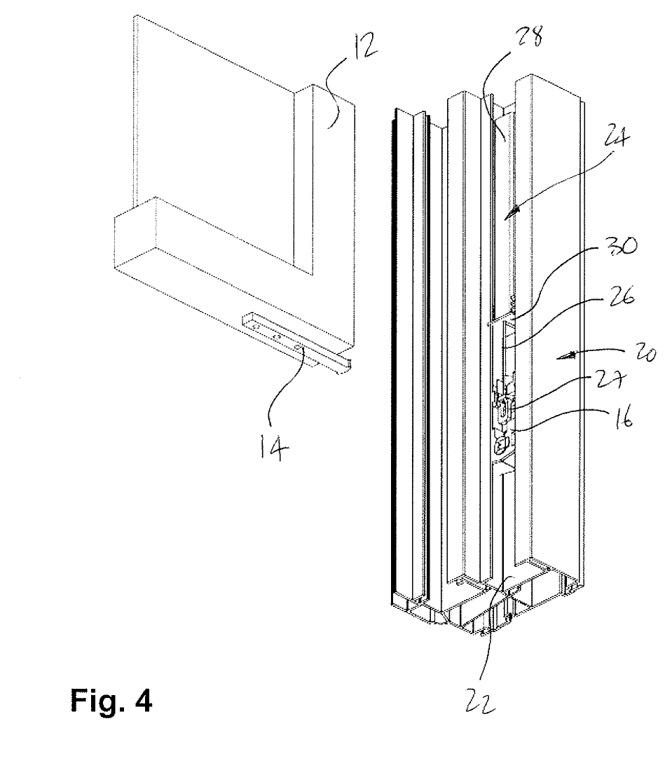

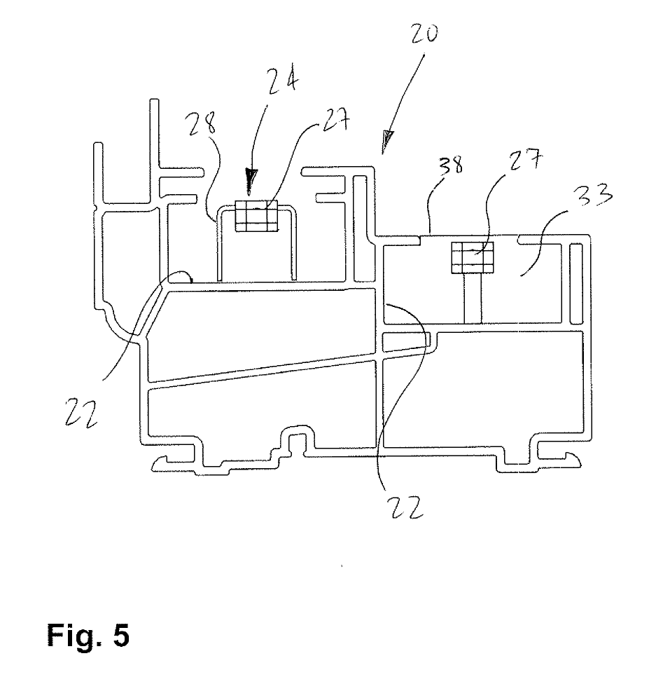

A jamb portion is generally shown at 20. Referring concurrently to FIGS. 1 and 4, the jamb portion 20 defines a channel 22 that will accommodate a balance 24. The jamb portion 20 is an extruded member that forms with other similar jamb portions 20 a jamb upon which the sash window panel 12 is mounted.

Referring to FIG. 4, the balance 24 is connected to the sash window panel 12 so as to maintain the sash window panel in position at a selected degree of opening of the window. The balance 24 has a cord 26 at a first end of which is connected the shoe 16 by way of a connector 27. The balance 24 has a body defined by a U-shaped housing 28, positioned within the channel 22 of the jamb portion 20. A spring-and-pulley mechanism (i.e., biasing mechanism) is accommodated within the housing 28. The tension of the spring in the balance is used to support the weight of the window sash panel 12, as is the common function of the balance.

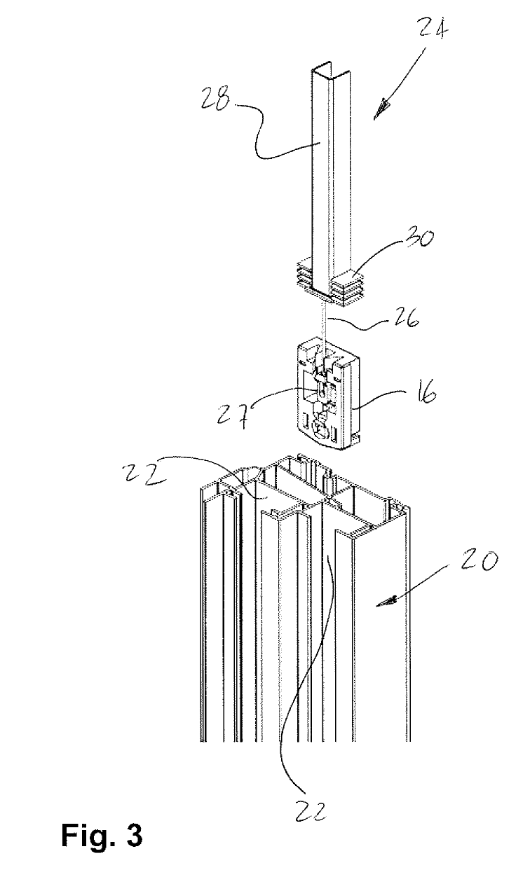

Referring to FIGS. 3 and 4, a plug 30 is provided for the channels 22, as air/water infiltration (i.e., chimney effect) occurs therethrough. The plug 30 is fitted at a bottom end of the housing 28 so as to generally prevent air/water infiltration between the interior and the exterior of the window system 10.

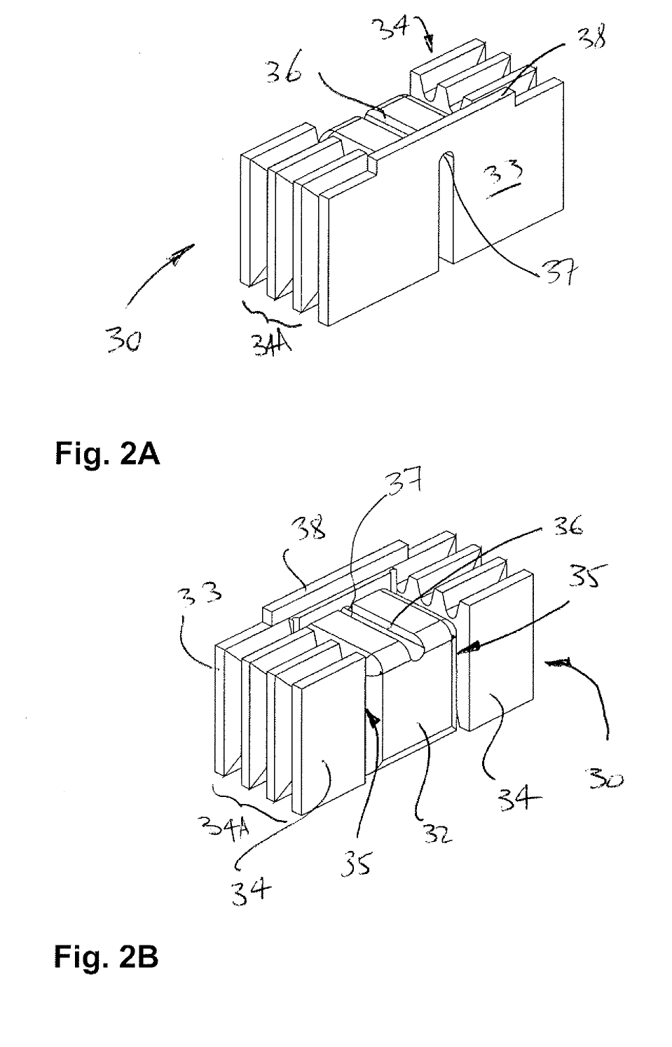

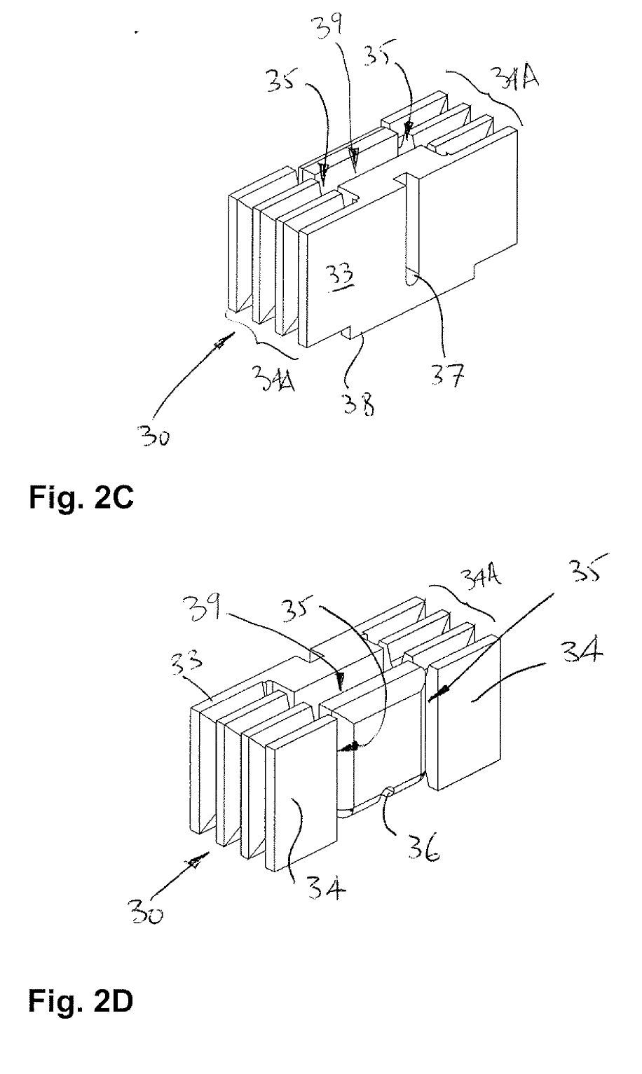

Referring to FIGS. 2A to 2D, the plug 30 is shaped so as to be connected to the bottom end of the housing 28, as is illustrated in FIG. 3. More specifically, the plug 30 has a sealing member having a central body portion 32 projecting from an end portion 33. Wings 34, in the form of a plurality of spaced-apart sealing sub-members, are provided on opposed sides of the central body portion 32, and are separated therefrom by spacings 35 shaped so as to be mated to an end of the housing 28. The wings 34 have ribs 34A well suited to sealingly contact flat surfaces, such as the interior of the channel 22, so as to define air pockets between the plug 20, the jamb portion 20 and the housing 28 of the balance 24, thereby increasing the insulation value of the plug 30 as installed in the window jamb 20.

A trough 36 extends through the central body portion 32 and forms an opening 37 in the end portion 33 so as to allow the cord 26 to pass through the plug 30. A lip 38 is formed on the end portion 33 of the plug 20, so as to fill the space between the opening in the channel 22 of the jamb portion 20 and the sash window panel 12. The plug 30 is squeezed into the channel 22 to seal off the end of the channel 22 while allowing the cord 26 to pass therethrough.

As seen in FIGS. 2C and 2D, the central body portion 32 forms a hook by way of the groove 39. This hook connector configuration is provided to hook the central body portion 32 to hold a rod (not shown) transversely positioned within the housing 28, adjacent to the end thereof. The plug 30 is releasable from secured engagement with the balance 24.

Referring concurrently to FIGS. 3 and 4, the plug is suitably connected to a bottom end of the balance 24. The cord 26 passes through the balance 24, such that the cord 26 is connected to the shoe 16 by way of the connector 27. The cord 26 is therefore allowed to move freely with respect to the plug 30. The block-and-tackle balance 24 may thus support the sash window panel 12 and assist the user displacing the panel 12, which assistance is through the cord 26, even when the plug 30 is used.

Referring to FIG. 5, the plug 30 is illustrated as blocking the channel 22, so as to prevent infiltration though the channel 22 resulting from the chimney effect, as compared with the adjacent channel 22′ having a balance 24′ not provided with the plug 30.

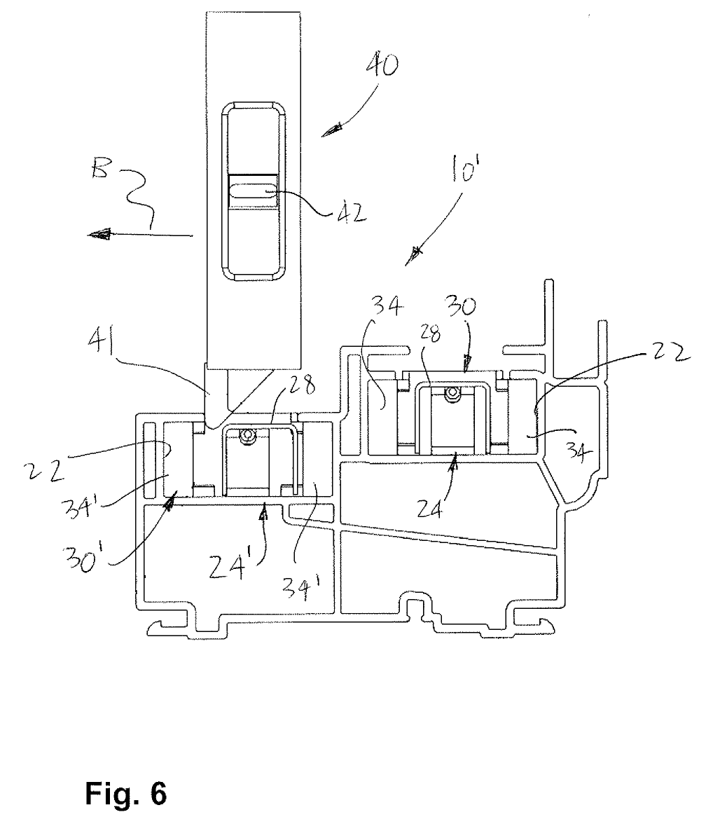

Referring to FIG. 6, a latch mechanism is generally illustrated at 40. The latch mechanism 40 is provided at the top of the sash window panel 12. The latch mechanism 40 has a latch bolt 41 that enters the channel 22, thereby preventing rotation along direction B of the sash window panel 12 about the shoe 16 (FIG. 1). The latch bolt 41 is manually withdrawn from the channel 22 by moving the detent 42.

In some window systems such as the one illustrated at 10′ in FIG. 6, the block-and-tackle balance 24 is offset from a central position within the channel 22 so as not to have the latch bolt 41 come into contact with the housing 28. In FIG. 6, the centrally positioned balance is illustrated by 24, whereas the offset balance is indicated as 24′. It is seen that the latch bolt 41 does not come into contact with the housing 28 of the balance 24′.

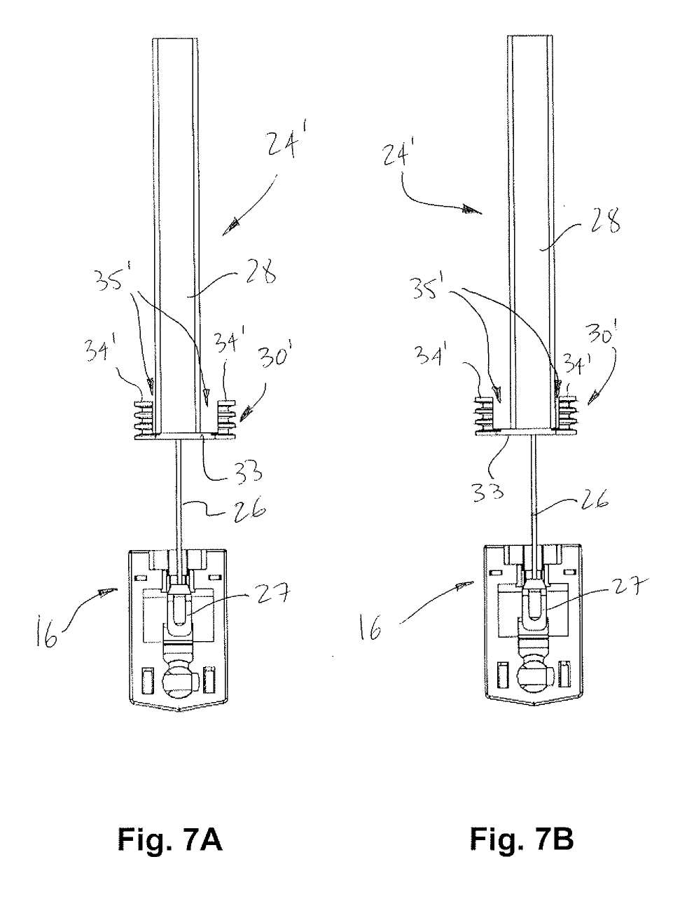

Therefore, referring concurrently to FIGS. 6, 7A and 7B, a universal plug 30′ has been defined to be used with such offset balances 24′ More specifically, considering that a sash-type window system typically has a block-and-tackle balance on both its right-hand side and left-hand side, a universal plug 30′ is shaped so as to fit the balance 24′ notwithstanding the side of the window.

The universal plug 30′ has wider spacings 35′ when compared to the plug 30 of FIGS. 2A to 2D, and therefore shorter wings 34′ and central body portion (not shown). The universal plug 30′ has a single opening 37, as the cord 26 is not restricted to being centered in the housing 28—the cord 26 can thus line up with its attachment point in the shoe 16.

Referring to FIGS. 7A and 7B, the universal plug 30′ is shown on block-and-tackle balances 24′ used on different side jambs of a window system.

In order to seal off the channel 22, the plugs 30 and 30′ are preferably made of polymeric material. One suitable material is Neoprene™ (e.g., 70 duro). Other materials of various densities and hardness are considered.

1. A sealing plug for a block-and-tackle balance comprising:
a sealing member having an outer periphery shaped so as to conform to an inner surface of a channel of a window jamb in which the block-and-tackle balance is accommodated;
an opening in the sealing member allowing a cord of the block-and-tackle balance to pass therethrough such that the cord is movable with a movement of a window panel; and
a connector configuration in the sealing member and releasably secured to a bottom end of the block-and-tackle balance.

2. The sealing plug according to claim 1, wherein the outer periphery of the sealing member has a generally rectangular section to conform to the inner surface of the channel.

3. The sealing plug according to claim 1, wherein the sealing member has a plurality of spaced-apart horizontal sealing sub-members each conforming to the inner surface of the channel of the window jamb to form air pockets between the sealing member, the channel of the window jamb and the block-and-tackle assembly.

4. The sealing plug according to claim 1, wherein the sealing member has a lip projecting from the outer periphery, the lip being provided to fill a space between an opening of the channel of the window jamb and a sash window panel.

5. The sealing plug according to claim 1, wherein the connector configuration has a horizontal groove defined in the sealing member so as to hook the sealing member to a transverse rod at an end of the block-and-tackle balance.

6. The sealing plug according to claim 5, wherein the sealing member has two parallel vertical spacings defining a central body portion in the sealing member with the central body portion enclosing said horizontal groove, the two parallel vertical spacings for receiving parallel walls of a U-shaped housing of the block-and-tackle balance when the sealing member is connected to the bottom end of the block-and-tackle balance, the parallel vertical spacings communicating with the horizontal groove.

7. The sealing plug according to claim 1, wherein the sealing member has two parallel vertical spacings defining a central body portion in the sealing member, the two parallel vertical spacings receiving parallel walls of a U-shaped housing of the block-and-tackle balance when the sealing member is connected to the bottom end of the block-and-tackle balance.

8. The sealing plug according to claim 7, wherein a width of each said parallel vertical spacing is greater than a thickness of each said parallel wall of the U-shaped housing, and a width of the central body portion is lesser than a width of an interior channel of the U-shaped housing, to allow a horizontal position adjustment between the sealing plug and the block-and-tackle balance for a block-and-tackle balance not centered in the window jamb.

9. The sealing plug according to claim 1, wherein the sealing plug is integrally made of Neoprene™.

10. A block-and-tackle balance assembly comprising:
a block-and-tackle balance having a U-shaped housing positioned vertically in a channel of a window jamb, the block-and-tackle balance having a biasing mechanism accommodated in the U-shaped housing and a cord connected to the biasing mechanism and projecting from a bottom end of the U-shaped housing to support a shoe connected with a sash window panel; and
a sealing plug having a sealing member with an outer periphery shaped so as to conform to the channel of the window jamb, an opening in the sealing member allowing the cord to pass therethrough such that the cord is movable with a movement of the shoe, the sealing member being releasably secured to the bottom end of the block-and-tackle balance by a connector configuration.

11. The block-and-tackle balance assembly according to claim 10, wherein the outer periphery of the sealing member has a generally rectangular section to conform to the inner surface of the channel.

12. The block-and-tackle balance assembly according to claim 10, wherein the sealing member has a plurality of spaced-apart horizontal sealing sub-members each conforming to the inner surface of the channel of the window jamb to form air pockets between the sealing member, the channel of the window jamb and the block-and-tackle assembly.

13. The block-and-tackle balance assembly according to claim 10, wherein the sealing member has a lip projecting from the outer periphery, the lip being provided to fill a space between an opening of the channel of the window jamb and the sash window panel.

14. The block-and-tackle balance assembly according to claim 10, wherein a transverse rod is provided in the U-shaped housing at the bottom end thereof, and the sealing member has a horizontal groove so as to hook onto the transverse rod.

15. The block-and-tackle balance assembly according to claim 14, wherein the sealing member has two parallel vertical spacings defining a central body portion in the sealing member with the central body portion enclosing said horizontal groove, the two parallel vertical spacings for receiving parallel walls of the U-shaped housing of the block-and-tackle balance when the sealing member is connected to the bottom end of the block-and-tackle balance, the parallel vertical spacings communicating with the horizontal groove.

16. The block-and-tackle balance assembly according to claim 10, wherein the sealing member has two parallel vertical spacings defining a central body portion in the sealing member, the two parallel vertical spacings receiving parallel walls of the U-shaped housing of the block-and-tackle balance when the sealing member is connected to the bottom end of the block-and-tackle balance.

17. The block-and-tackle balance assembly according to claim 16, wherein a width of each said parallel vertical spacing is greater than a thickness of each said parallel wall of the U-shaped housing, and a width of the central body portion is lesser than a width of an interior of the U-shaped housing, to allow a horizontal position adjustment between the sealing plug and the block-and-tackle balance when the block-and-tackle balance is not centered in the window jamb.

18. The block-and-tackle balance assembly according to claim 10, wherein the sealing plug is integrally made of Neoprene™.
